(19) United States
(12) Patent Application Publication
(10) Pub. No.: US 2012/0133486 A1
(43) Pub. Date: May 31, 2012

(54) MOBILE TERMINAL AND METHOD OF CONTROLLING THE SAME

(76) Inventors: Seungyong PARK, Seoul (KR); Woosik Choi, Seoul (KR); Hyorim Park, Incheon (KR)

(21) Appl. No.: 12/955,570

(22) Filed: Nov. 29, 2010

(51) Int. Cl. G08B 5/22

(52) U.S. Cl. 340/8.1

(57) ABSTRACT

A mobile terminal and a method of controlling the same are provided. An idle screen (or wall paper) provided through a display unit included in the mobile terminal or the display unit can be controlled in various manners by using position information of the mobile terminal. Accordingly, a user can be provided with required information using the position information rapidly and efficiently.

### BACKGROUND OF THE INVENTION

1. Field of the Invention

The present invention relates to a mobile terminal and a method of controlling the same.

2. Discussion of the Related Art

Mobile terminals are expected to actively provide location-based service (LBS). The LBS means services provided by using the current location of a mobile terminal or a user or other position information.

Accordingly, there is a growing need to develop various services that can be provided using the position information of a mobile terminal and develop easy and efficient user interface related to LBS.

### SUMMARY OF THE INVENTION

Accordingly, one object of the present invention is to address the above-noted and other drawbacks of the related art.

Another object of the present invention is to provide a mobile terminal and a method of controlling the same, capable of controlling an idle screen (or wall paper) provided through a display unit included in the mobile terminal or the display unit in various manners using position information of the mobile terminal.

To accomplish the objects of the present invention, according to an aspect of the present invention, there is provided a mobile terminal comprising a display unit; a position information unit obtaining the current location of the mobile terminal; and a controller controlling the position information unit to obtain the current location and controlling an idle screen displayed on the display unit according to the obtained current location.

To accomplish the objects of the present invention, according to another aspect of the present invention, there is provided a mobile terminal comprising a display unit; a position information unit obtaining the current location of the mobile terminal; and a controller controlling the position information unit to obtain the current location and variably controlling the state of the display unit according to the obtained current location.

To accomplish the objects of the present invention, according to another aspect of the present invention, there is provided a method of controlling a mobile terminal, comprising the steps of obtaining the current location of the mobile terminal and controlling an idle screen displayed on a display unit included in the mobile terminal according to the obtained current location.

To accomplish the objects of the present invention, according to another aspect of the present invention, there is provided a method of controlling a mobile terminal, comprising the steps of obtaining the current location of the mobile terminal and variably controlling the state of a display unit included in the mobile terminal according to the obtained current location.

According to the present invention, an idle screen (or wall paper) provided through the display unit included in the mobile terminal is varied with the current location of the mobile terminal, and thus information required for the user in the current location can be rapidly provided and user convenience can be remarkably improved.

Furthermore, the idle screen (or wall paper) can be variably controlled in consideration of the current location of the mobile terminal and the user (or holder) of the mobile terminal to efficiently provide information most suitable for the current location and the user (or holder).

Moreover, the display unit is variably controlled according to the current location of the mobile terminal, and thus the display unit can be controlled to be in a state most suitable for the current location.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of the present invention;

FIG. 2 illustrates environments to which a method of controlling a mobile terminal according to a first embodiment of the present invention can be applied;

FIG. 3 is a flowchart showing the method of controlling a mobile terminal according to the first embodiment of the present invention;

FIGS. 4 through 10 are views for explaining the method of controlling a mobile terminal according to the first embodiment of the present invention;

FIG. 11 is a flowchart showing a method of controlling a mobile terminal according to a second embodiment of the present invention;

FIGS. 12 and 13 are views for explaining the method of controlling a mobile terminal according to the second embodiment of the present invention;

FIG. 14 illustrates an exemplary environment to which a method of controlling a mobile terminal according to a third embodiment of the present invention can be applied;

FIG. 15 illustrates an exemplary implementation of the method of controlling a mobile terminal according to the third embodiment of the present invention;

FIG. 16 is a flowchart showing a method of controlling a mobile terminal according to a fourth embodiment of the present invention;

FIGS. 17 and 18 are views for explaining the method of controlling a mobile terminal according to the fourth embodiment of the present invention;

FIG. 19 illustrates an exemplary implementation of the method of controlling a mobile terminal according to the fourth embodiment of the present invention;

FIG. 20 is a flowchart showing a method of controlling a mobile terminal according to a fifth embodiment of the present invention;

FIGS. 21 and 22 are views for explaining the method of controlling a mobile terminal according to the fifth embodiment of the present invention;

FIGS. 23, 24, 25 and 26 illustrate other implementations of the method of controlling a mobile terminal according to the fourth and fifth embodiments of the present invention;

FIG. 27 is a flowchart showing a method of controlling a mobile terminal according to a sixth embodiment of the present invention;

FIG. 28 is a view for explaining the method of controlling a mobile terminal according to the sixth embodiment of the present invention;

FIG. 29 is a flowchart showing a method of controlling a mobile terminal according to a seventh embodiment of the present invention;

FIGS. 30, 31 and 32 are views for explaining the method of controlling a mobile terminal according to the seventh embodiment of the present invention; and

FIG. 33 illustrates an example of a wireless communication system according to an embodiment of the present invention and

FIG. 34 illustrates an example of a wireless LAN system according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

Hereinafter, a mobile terminal relating to the present invention will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

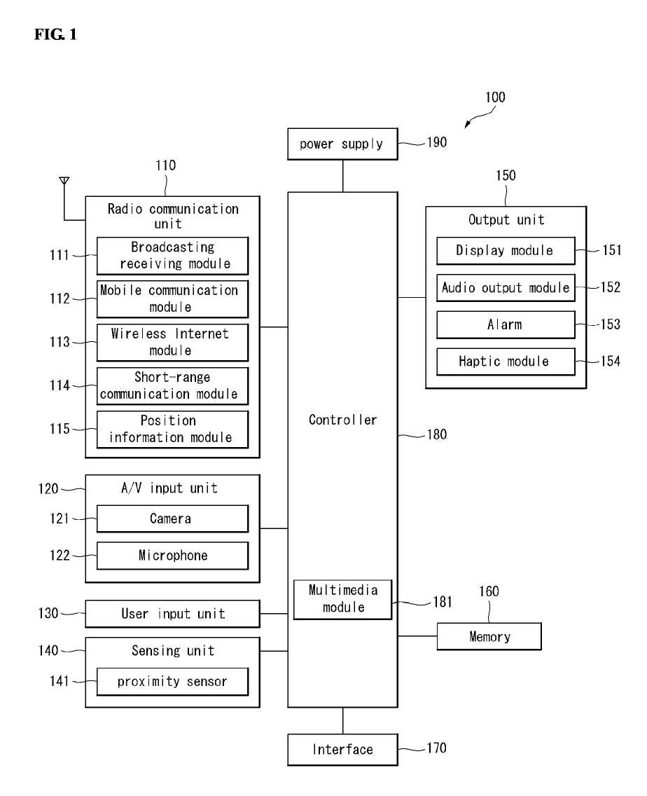

FIG. 1 is a block diagram of an implementation of a mobile terminal 100. The mobile terminal 100 can include a radio communication unit 110, an audio/video (A/V) input unit 120, a user input unit 130, a sensing unit 140, an output unit 150, a memory 160, an interface 170, a controller 180, and a power supply 190. The components shown in FIG. 1 are not essential parts and the number of components included in the mobile terminal can be varied.

In addition, the radio communication unit 110 includes at least one module that enables radio communication between the mobile terminal 100 and a radio communication system or between the mobile terminal 100 and a network in which the mobile terminal 100 is located. For example, the radio communication unit 110 includes a broadcasting receiving module 111, a mobile communication module 112, a wireless Internet module 113, a short-range communication module 114 and a position information module 115.

The broadcasting receiving module 111 receives broadcasting signals and/or broadcasting related information from an external broadcasting management server through a broadcasting channel.

Also, the broadcasting channel can include a satellite channel and a terrestrial channel, and the broadcasting management server can be a server that generates and transmits broadcasting signals and/or broadcasting related information or a server that receives previously created broadcasting signals and/or broadcasting related information and transmits the broadcasting signals and/or broadcasting related information to a terminal.

Further, the broadcasting signals can include not only TV broadcasting signals, radio broadcasting signals and data broadcasting signals, but also signals in the form of combination of a TV broadcasting signal and a radio broadcasting signal. In addition, the broadcasting related information can be information on a broadcasting channel, a broadcasting program or a broadcasting service provider, and can be provided even through a mobile communication network. In the latter case, the broadcasting related information can be received by the mobile communication module 112.

Also, the broadcasting related information can exist in various forms. For example, the broadcasting related information can exist in the form of an electronic program guide (EPG) of the digital multimedia broadcasting (DMB) system or in the form of an electronic service guide (ESG) of the digital video broadcast-handheld (DVB-H) system.

In addition, the broadcasting receiving module 111 receives broadcasting signals using various broadcasting systems. Particularly, the broadcasting receiving module 111 can receive digital broadcasting signals using digital broadcasting systems such as the digital multimedia broadcasting-terrestrial (DMB-T) system, the digital multimedia broadcasting-satellite (DMB-S) system, the media forward link only (MediaFLO) system, the DVB-H and integrated services digital broadcast-terrestrial (ISDB-T) systems, etc. The broadcasting receiving module 111 can also be constructed to be suited to broadcasting systems providing broadcasting signals other than the above-described digital broadcasting systems.

Further, the broadcasting signals and/or broadcasting related information received through the broadcasting receiving module 111 can be stored in the memory 160.

The mobile communication module 112 transmits/receives a radio signal to/from at least one of a base station, an external terminal and a server on a mobile communication network. The radio signal can include a voice call signal, a video telephony call signal or data in various forms according to transmission and reception of text/multimedia messages.

In addition, the wireless Internet module 113 corresponds to a module for wireless Internet access and can be included in the mobile terminal 100 or externally attached to the mobile terminal 100. A wireless LAN (WLAN) (Wi-Fi), wireless broadband (Wibro), world interoperability for microwave access (Wimax), high speed downlink packet access (HSDPA) and so on can be used as a wireless Internet technique.

Also, the short-range communication module 114 corresponds to a module for local area communication. Further, bluetooth, radio frequency identification (RFID), infrared data association (IrDA), ultra wideband (UWB) and ZigBee can be used as a local area communication technique.

The position information module 115 confirms or obtains the position of the mobile terminal. The position information module 115 can obtain position information by using a global navigation satellite system (GNSS). The GNSS is a terminology used to explain radio navigation satellite systems which revolve around the earth to send reference signals to radio navigation receivers of a predetermined type such that the radio navigation receivers can determine their positions on or near the surface of the earth. The GNSS include the global position system (GPS) administrated by the United States, Galileo administrated by Europe, Global Orbiting Navigation Satellite System (GLONASS) administrated by Russia, COMPASS administrated by China and Quasi-Zenith Satellite System (QZSS) administrated by Japan.

In more detail, a global positioning system (GPS) module is a representative example of GNSS. In addition, the GPS module 115 can calculate information on distances between one point or object and at least three satellites and information on the time when the distance information is measured and apply trigonometry to the obtained distance information to obtain three-dimensional position information on the point or object according to the latitude, longitude and altitude at a predetermined time. Furthermore, a method of calculating position and time information using three satellites and correcting the calculated position and time information using another satellite can also used. In addition, the GPS module 115 continuously calculates the current position in real time and calculates velocity information using the position information.

Referring to FIG. 1, the A/V input unit 120 is used to input an audio signal or a video signal and includes a camera 121 and a microphone 122. The camera 121 processes image frames of still images or moving images obtained by an image sensor in a video telephony mode or a photographing mode. Further, the processed image frames can be displayed on a display unit 151.

Also, the image frames processed by the camera 121 can be stored in the memory 160 or transmitted to an external device through the radio communication unit 110. The mobile terminal 100 can also include at least two cameras. The microphone 122 receives an external audio signal in a call mode, a recording mode or a speed recognition mode and processes the received audio signal into electric audio data.

The audio data can then be converted into a form that can be transmitted to a mobile communication base station through the mobile communication module 112 and output in the call mode. Further, the microphone 122 can employ various noise removal algorithms for removing noise generated when the external audio signal is received.

In addition, the user input unit 130 receives input data for controlling the operation of the terminal from a user. The user input unit 130 can include a keypad, a dome switch, a touch pad (constant voltage/capacitance), jog wheel, jog switch and so on.

Also, the sensing unit 140 senses the current state of the mobile terminal 100, such as an open/close state of the mobile terminal 100, the position of the mobile terminal 100, whether a user touches the mobile terminal 100, the direction of the mobile terminal 100 and the acceleration/deceleration of the mobile terminal 100, and generates a sensing signal for controlling the operation of the mobile terminal 100.

For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can also include a proximity sensor 141.

In addition, the output unit 150 generates visual, auditory or tactile output and can include the display unit 151, an audio output module 152, an alarm 153 and a haptic module 154. Further, the display unit 151 displays information processed by the mobile terminal 100. For example, the display unit 151 displays a user interface (UI) or graphic user interface (GUI) related to a telephone call when the mobile terminal is in the call mode. The display unit 151 also displays a captured or/and received image, UI or GUI when the mobile terminal 100 is in the video telephony mode or the photographing mode.

In addition, the display unit 151 can include at least one of a liquid crystal display, a thin film transistor liquid crystal display, an organic light-emitting diode display, a flexible display and a three-dimensional display. Further, some of these displays can be of a transparent type or a light transmission type. That is, the display unit 151 can include a transparent display.

In more detail, the transparent display includes a transparent liquid crystal display. Further, the rear structure of the display unit 151 can also be of the light transmission type. Accordingly, a user can see an object located behind the body of the mobile terminal 100 through the transparent area of the body of the mobile terminal 100, which is occupied by the display unit 151.

The mobile terminal 100 can also include at least two display units 151. For example, the mobile terminal 100 can include a plurality of displays that are arranged on a single face at a predetermined distance or integrated displays. The plurality of displays can also be arranged on different sides.

In addition, when the display unit 151 and a sensor sensing touch (referred to as a touch sensor hereinafter) form a layered structure, which is referred to as a touch screen hereinafter, the display unit 151 can be used as an input device in addition to an output device. The touch sensor can be in the form of a touch film, a touch sheet and a touch pad, for example.

Further, the touch sensor can be constructed to convert a variation in pressure applied to a specific portion of the display unit 151 or a variation in capacitance generated at a specific portion of the display unit 151 into an electric input signal. The touch sensor can also be constructed to sense pressure of touch as well as the position and area of the touch.

Also, when the user applies touch input to the touch sensor, a signal corresponding to the touch input is transmitted to a touch controller. The touch controller then processes the signal and transmits data corresponding to the processed signal to the controller 180. Accordingly, the controller 180 can detect a touched portion of the display 151.

Referring to FIG. 1, the proximity sensor 141 of the sensing unit 140 can be located in an internal region of the mobile terminal, surrounded by the touch screen, or near the touch screen. The proximity sensor 141 senses an object approaching a predetermined sensing face or an object located near the proximity sensor 141 using an electromagnetic force or infrared rays without having mechanical contact. Further, the proximity sensor 141 has lifetime longer than that of a contact sensor and thus has a wide application in the mobile terminal 100.

In addition, the proximity sensor 141 includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc. Further, a capacitive touch screen is constructed such that proximity of a pointer is detected through a variation in an electric field according to the proximity of the pointer. In this instance, the touch screen (touch sensor) can be classified as a proximity sensor.

For convenience of explanation, the action of the pointer approaching the touch screen without actually touching the touch screen is referred to as “proximity touch” and an action of bringing the pointer into contact with the touch screen is referred to as “contact touch” in the following description. In addition, the proximity touch point of the pointer on the touch screen corresponds to a point of the touch screen to which the pointer touches the touch screen.

Further, the proximity sensor 141 senses the proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can then be displayed on the touch screen.

Also, the audio output module 152 can output audio data received from the radio communication unit 110 or stored in the memory 160 in a call signal receiving mode, a telephone call mode or a recording mode, a speech recognition mode and a broadcasting receiving mode. Further, the audio output module 152 outputs audio signals related to functions (for example, a call signal incoming tone, a message incoming tone, etc.) performed in the mobile terminal 100. The audio output module 152 can include a receiver, a speaker, a buzzer, etc.

In addition, the alarm 153 outputs a signal for indicating the generation of an event of the mobile terminal 100. For example, alarms can be generated when receiving a call signal, receiving a message, inputting a key signal, inputting touch, etc. The alarm 153 can also output signals in forms different from video signals or audio signals, for example, a signal for indicating generation of an event through vibration. The video signals or the audio signals can be also output through the display unit 151 or the audio output module 152.

Also, the haptic module 154 generates various haptic effects that the user can feel. One representative example of the haptic effects is vibration. The intensity and pattern of vibration generated by the haptic module 154 can also be controlled. For example, different vibrations can be combined and output or can be sequentially output.

Further, the haptic module 154 can generate a variety of haptic effects including an effect of stimulus according to arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 can also not only transmit haptic effects through direct contact but also allow the user to feel haptic effects through a kinesthetic sense of the user's fingers or arms. The mobile terminal 100 can also include multiple haptic modules 154.

In addition, the memory 160 can store a program for the operation of the controller 180 and temporarily store input/output data (for example, phone book, messages, still images, moving images, etc.). The memory 160 can also store data about vibrations and sounds in various patterns, which are output from when a touch input is applied to the touch screen.

Further, the memory 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can also operate in relation to a web storage performing the storing function of the memory 160 on the Internet.

The interface 170 serves as a path to external devices connected to the mobile terminal 100. Further, the interface 170 receives data from the external devices or power and transmits the data or power to the internal components of the mobile terminal 100 or transmits data of the mobile terminal 100 to the external devices. Also, the interface 170 can include a wired/wireless headset port, an external charger port, a wired/wireless data port, a memory card port, a port for connecting a device having a user identification module, an audio I/O port, a video I/O port, an earphone port, etc., for example.

In addition, the interface 170 can also interface with a user identification module that is a chip that stores information for authenticating the authority to use the mobile terminal 100. For example, the user identification module can be a user identify module (UIM), a subscriber identify module (SIM) and a universal subscriber identify module (USIM). An identification device including the user identification module can also be manufactured in the form of a smart card. Accordingly, the identification device can be connected to the mobile terminal 100 through a port of the interface 170.

The interface 170 can also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle can be used as signals for confirming whether the mobile terminal is correctly set in the cradle.

In addition, the controller 180 controls the overall operations of the mobile terminal. For example, the controller 180 performs control and processing for voice communication, data communication and video telephony. As shown in FIG. 1, the controller 180 also includes a multimedia module 181 for playing multimedia. Also, the multimedia module 181 can be included in the controller 180 as shown in FIG. 1 or can be separated from the controller 180.

Further, the controller 180 can perform a pattern recognition process capable of recognizing handwriting input or picture-drawing input applied to the touch screen as characters or images.

In addition, the power supply 190 receives external power and internal power and provides power required for the operations of the components of the mobile terminal under the control of the controller 180.

Various embodiments described in this specification can be implemented in recording media readable by computers or similar devices using software, hardware or a combination thereof, for example.

According to hardware implementation, the embodiments of the present invention can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for executing functions. In some cases, the embodiments can be implemented by the controller 180.

According to software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

Embodiments of the present invention will be explained on the assumption that the display unit 151 is a touch screen for convenience of explanation. As described above, the touch screen 151 can execute both an information display function and an information input function. However, the present invention is not limited thereto. In addition, ‘touch’ described in this document can include both contact touch and proximity touch.

According to the technical spirit of the present invention, the idle screen displayed on the display unit 151 can be controlled in various manners according to the current location of the mobile terminal 100.

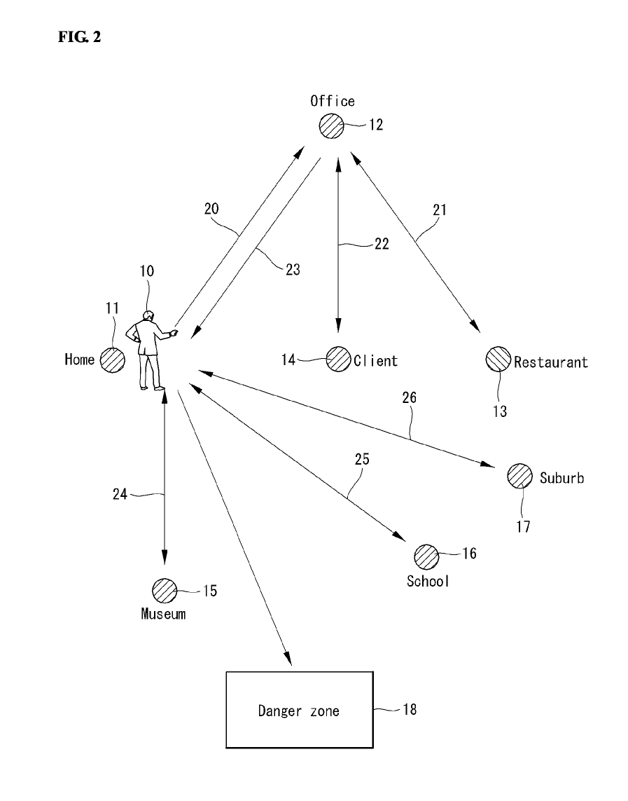

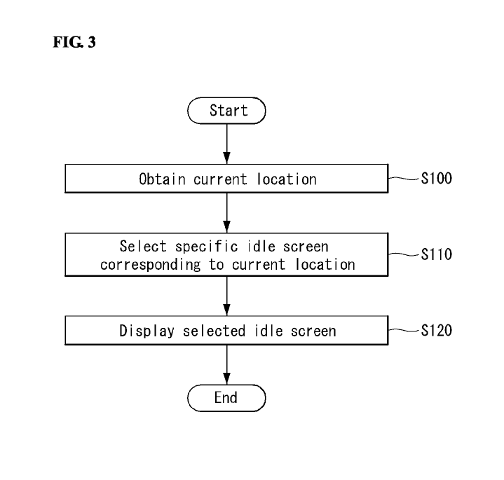

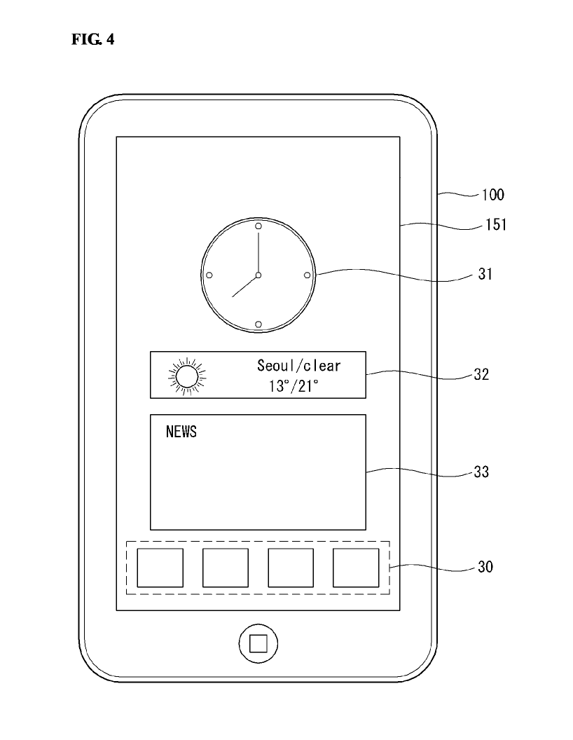

FIG. 2 illustrates environments to which a method of controlling a mobile terminal according to a first embodiment of the present invention, FIG. 3 is a flowchart showing the method of controlling a mobile terminal according to the first embodiment of the present invention, and FIGS. 4 through 10 are views for explaining the method of controlling a mobile terminal according to the first embodiment of the present invention.

A method of managing icons of a mobile terminal according to a first embodiment of the present invention may be implemented in the mobile terminal 100 described with reference to FIG. 1. The method of controlling a mobile terminal according to the first embodiment of the present invention and an operation of the mobile terminal 100 for implementing the controlling method will now be explained with reference to required drawings.

Referring to FIGS. 1 and 3, the controller 180 may control the position information module 115 to obtain the current location of the mobile terminal 100 in operation S100.

As described above, the position information module 115 can obtain the current location of the mobile terminal 100 using GNSS.

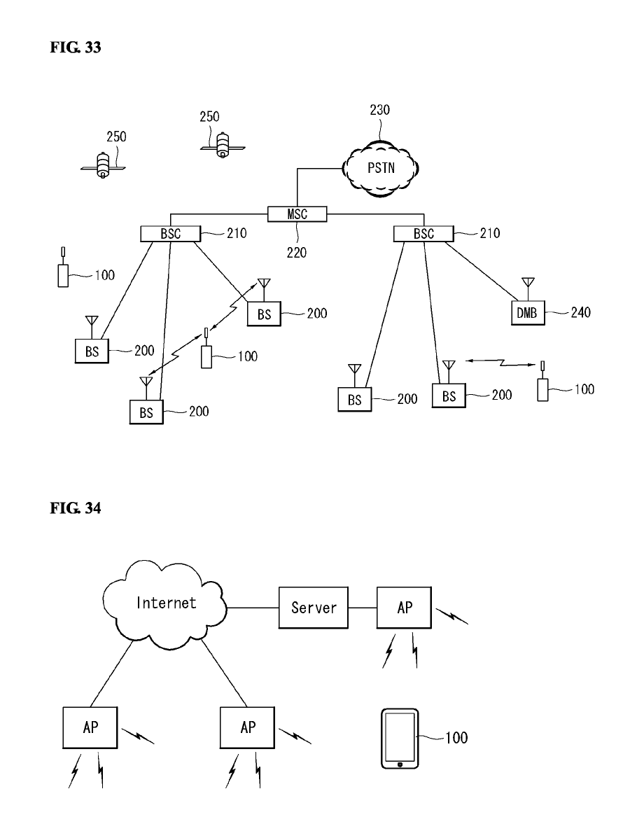

In addition, the position information module 115 can obtain the current location of the mobile terminal 100 using cell-ID method and wireless LAN access point detecting method, which will be described in detail later with reference to FIGS. 33 and 34.

The memory 160 may store information about a plurality of idle screens having different configurations. At least parts of the idle screens may correspond to a unique position. This corresponding relationship may be stored in the memory 160.

For example, a first idle screen among the plurality of idle screens may correspond to a first position and a second idle screen may correspond to a second position.

The plurality of idle screens may have different icon configurations for different positions. For example, the first and second idle screens may have different icon configurations.

The controller 180 may select a specific idle screen corresponding to the obtained current location from the plurality of idle screens stored in the memory 160 in operation S110 and display the selected idle screen on the display unit 151 according to the configuration of the selected idle screen in operation S120.

Referring to FIG. 2, a user 10 of the mobile terminal 100 may get up in the morning at home 11 and go to the office 12. Then, the user 10 may go to a restaurant 13 for lunch and visit a client 14 in the afternoon. In addition, the user 10 may finish the work, leave the office 12 and go home 11. Furthermore, the user 10 may go to school 16 part-time or on weekend, to go a museum 15 on weekend or go driving to the suburbs 17.

In this manner, the user 10 moves to various places in daily life. The first embodiment of the present invention may provide different idle screens according to various places or locations to which the user 10 moves.

FIG. 4 illustrates an exemplary idle screen that can be provided for a time from when the user 10 gets up to when the user 10 goes to the office.

The idle screen shown in FIG. 4 includes a time widget 31, a weather widget 32 and a news widget 33 providing news information. Accordingly, the user 10 can be automatically provided with the current time, today's weather and major news information when getting up in the morning even if the user 10 does not operate a menu or execute a function.

In addition, the idle screen shown in FIG. 4 displays a menu group 30 called a global menu. The menu group 30 can be set such that the menu group 30 can be maintained even when the idle screen is changed. For example, the menu group 30 may include functions frequently used by users, such as a call menu, phone book menu, message menu, main menu, etc.

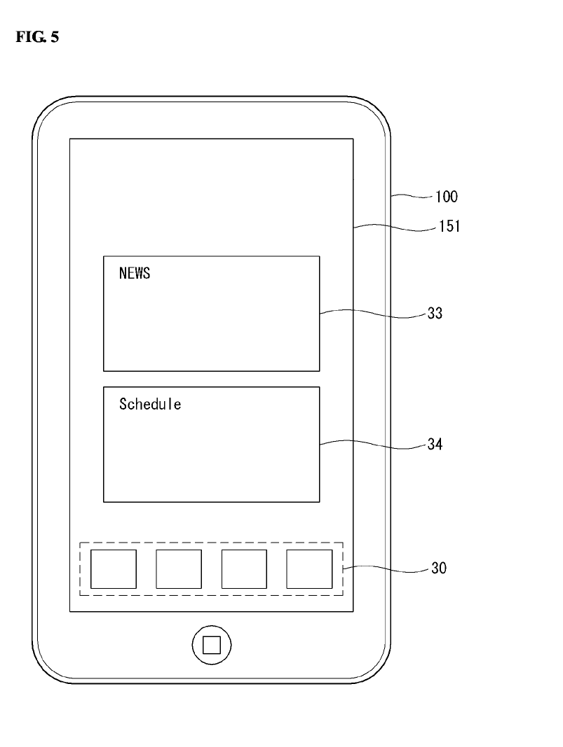

Referring to FIG. 5, the menu group 30 can be maintained even when the idle screen displayed on the display unit 151 is changed. The technical characteristic of maintaining the menu group 30 does not restrict the technical spirit of the present invention and the menu group 30 can disappear when the idle screen is changed.

FIG. 5 illustrates an exemplary idle screen that can be provided while the user 10 goes to the office 12.

The idle screen shown in FIG. 5 may include the news widget 33 and a schedule information region 34 provided by a schedule application. The user 10 can be provided with news information through the news widget 33 and confirm stored information on various schedules through the schedule information region 34 while he goes to the office 12.

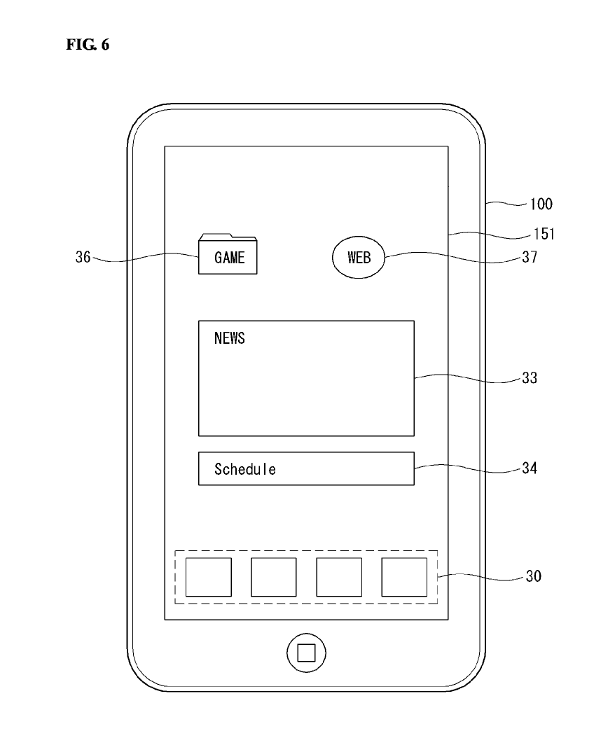

FIG. 6 illustrates an exemplary idle screen that can be provided when the user 10 arrives at the restaurant 13.

The idle screen shown in FIG. 6 may include a game folder 36, a web icon 37 used to drive a web browser, the news widget 33, and the schedule information region 34. The user 10 can enjoy various games by selecting the game folder 36 and enjoy web surfing by selecting the web icon 37 at the restaurant 13.

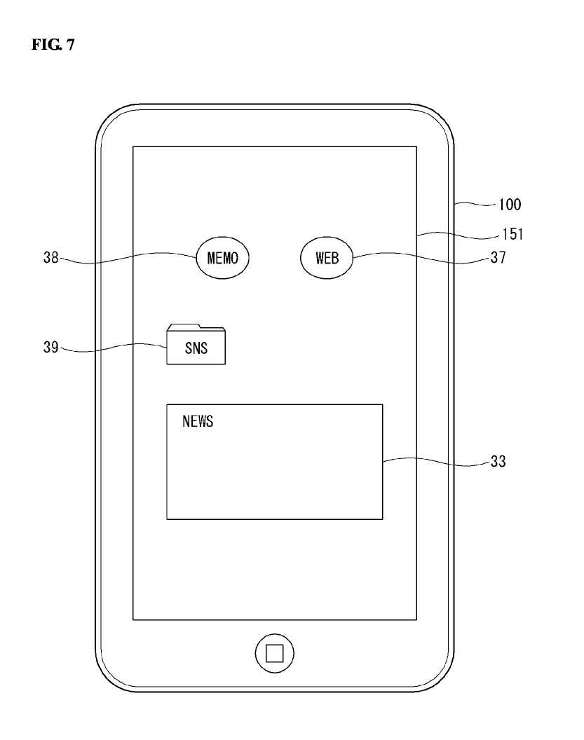

FIG. 7 illustrates an exemplary idle screen that can be provided while the user 10 goes to home 11 after work.

The idle screen shown in FIG. 7 may include the news widget 33, the web icon 37, a memo icon 38 used to access a notepad, a social network service (SNS) folder 39. The SNS folder 39 may include various SNS related applications for providing SNS.

The news widget 33 is included in all the idle screens shown in FIGS. 4, 5, 6 and 7. That is, a specific application or a specific menu, a specific icon or a specific widget corresponding to a specific application can be set such that it can be included in all of idle screens provided according to a variation in the current location of the mobile terminal.

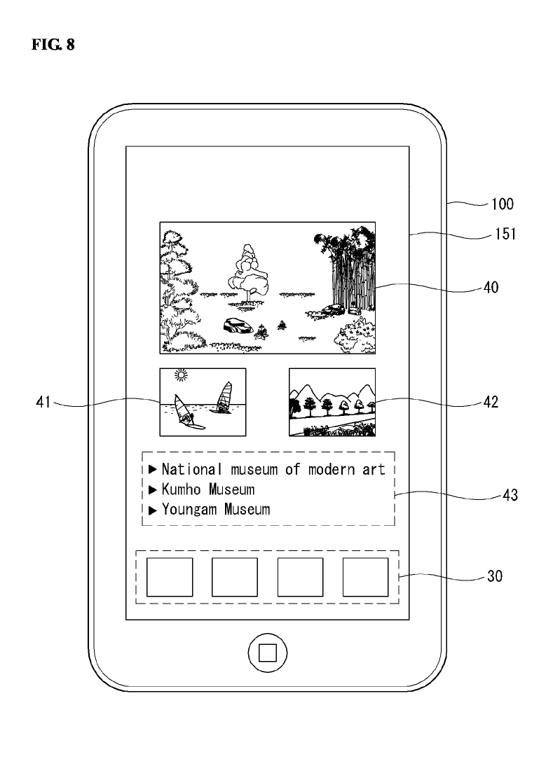

FIG. 8 illustrates an exemplary idle screen that can be provided when the user 10 is in the museum 15.

The idle screen shown in FIG. 8 may include multiple picture images 40, 41 and 42 and a museum information region 43 for accessing the museum 15 in which the user 10 is currently located or information about galleries other than the museum 15.

For example, the picture images 40, 41 and 42 are pictures that the museum 15 is exhibiting. The picture images 40, 41 and 42 may be received from the museum 15 through wireless communication. Furthermore, the picture images 40, 41 and 42 are pictures that the user 10 prefers and may be files stored in the memory 160. In addition, the user 10 can select a specific museum provided through the museum information region 43 to access a web site corresponding to the specific museum or receive information corresponding to the specific museum.

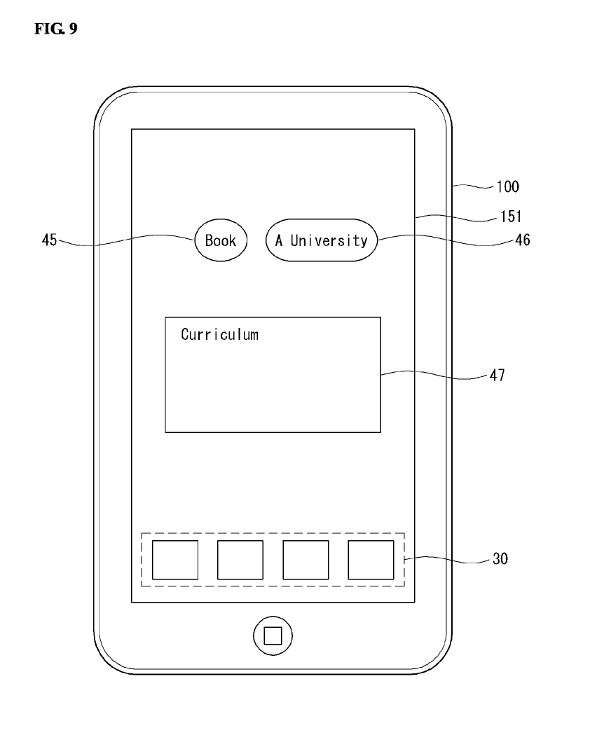

FIG. 9 illustrates an exemplary idle screen when the user 10 is located in the school 16.

The idle screen shown in FIG. 9 may include a book icon 45 corresponding to a book search widget for searching books housed in a library of the school 16 or to an application for providing e-book, a school icon 46 for accessing the homepage of the school 16, and a curriculum region 47 for providing information about subjects that the user 10 is currently taking.

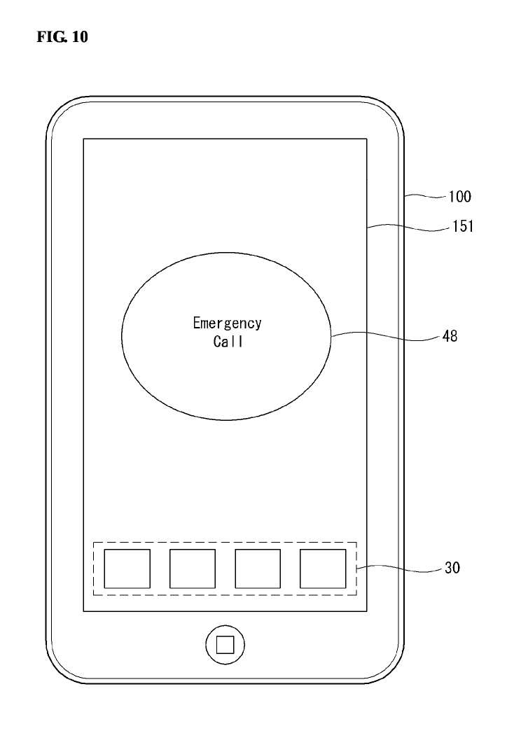

FIG. 10 illustrates an exemplary idle screen when the user 10 enters a danger zone 18 shown in FIG. 2.

The idle screen shown in FIG. 10 may include an emergency call icon 48 for emergency call used if the user 10 enters a predetermined danger zone 18 or the user 10 leaves his daily route. Accordingly, the user 10 can select the emergency call icon 48 when located in the danger zone 18 to inform a predetermined security center or protector that he is in danger.

AS described above with reference to FIGS. 4 through 10, the controller 180 can provide different idle screens according to the current location (place) of the mobile terminal 100. To achieve this, the controller 180 can generate information about the different idle screens having different configurations based on data about a pattern that the user 10 uses the mobile terminal 100, accumulated for a predetermined period of time.

Otherwise, the idle screens having different configurations can be set by the user 10. That is, the user can set the configuration of an idle screen that will be provided to the user in a specific location. For example, the user 10 can add a new icon to the idle screen shown in FIG. 4 or delete the existing icon or widget from the idle screen.

The controller 180 can provide a user interface by which the user 10 can edit the configuration of an idle screen corresponding to a specific location.

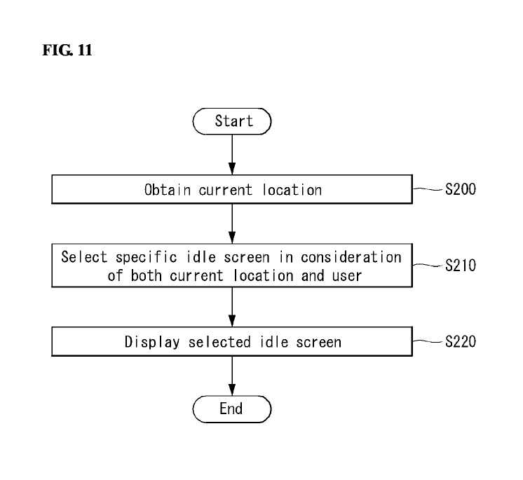

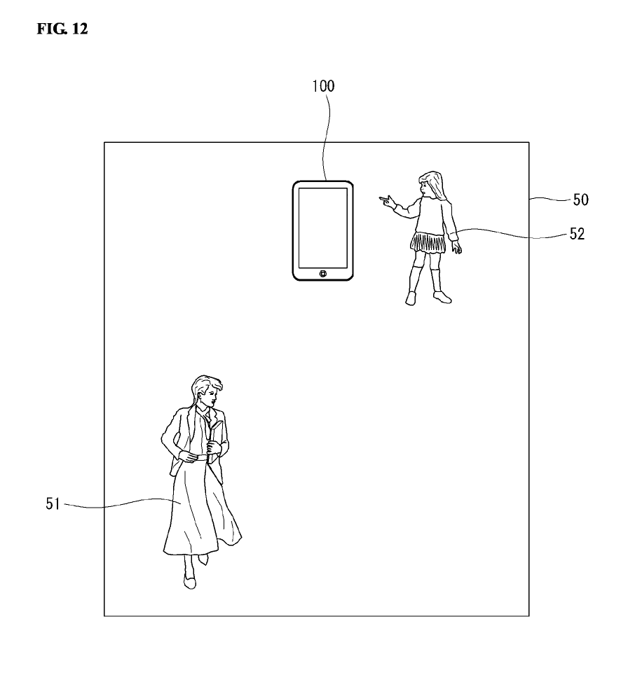

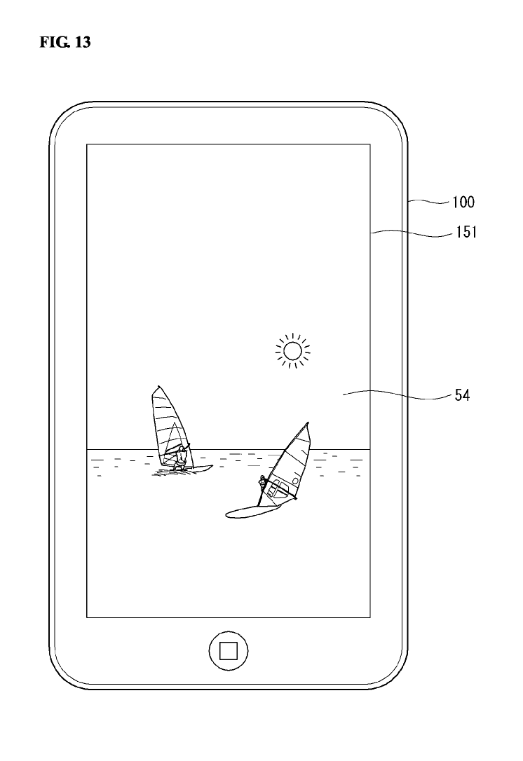

FIG. 11 is a flowchart showing a method of controlling a mobile terminal according to a second embodiment of the present invention, and FIGS. 12 and 13 are views for explaining the method of controlling a mobile terminal according to the second embodiment of the present invention.

A method of managing icons of a mobile terminal according to the second embodiment of the present invention may be implemented in the mobile terminal 100 described with reference to FIG. 1. The method of controlling a mobile terminal according to the second embodiment of the present invention and an operation of the mobile terminal 100 for implementing the controlling method will now be explained with reference to required drawings.

Referring to FIGS. 1 and 11, the controller 180 may obtain the current location of the mobile terminal 100 in operation S200. The operation S200 corresponds to the operation S100 of the method of controlling a mobile terminal according to the first embodiment of the present invention.

The controller 180 may select a specific idle screen from the plurality of idle screens stored in the memory 160 in consideration of the obtained current location and a user in operation S210 and display the selected idle screen on the display unit 151 in operation S330.

The user considered in the operation S210 may be the owner of the mobile terminal 100 or a holder who currently holds the mobile terminal 100. An owner may be different from a holder. For example, the owner of the mobile terminal 100 can lend a friend the mobile terminal 100. In this case, the friend is the holder.

FIG. 12 illustrates an exemplary environment to which the method of controlling a mobile terminal according to the second embodiment of the present invention can be applied.

Referring to FIG. 12, a mother 51 who is the owner of the mobile terminal 100 does not hold the mobile terminal 100 and a baby 52 holds the mobile terminal 100 and plays with the mobile terminal 100 at home 50. In this situation, the controller 180 may recognize that the baby 52 holds the mobile terminal 100 and display an idle screen corresponding to the attribute of the baby 52 and the location, that is, home 50, on the display unit 151.

Referring to FIG. 13, the controller 180 may display an image 54 helpful for emotional cultivation of the baby 52 and may not display any icon or widget on the idle screen to prevent the mobile terminal 100 from wrong or unnecessary operations.

Furthermore, when the baby 52 is in a place other than the home 50 even if the baby 52 holds the mobile terminal 100, the controller 180 can provide an idle screen corresponding to the place instead of the idle screen shown in FIG. 13.

In addition, the controller 180 may recognize the holder of the mobile terminal 100 in various manners. For example, the controller 180 can recognize the holder of the mobile terminal 100 by using an image acquired through the camera 121 of the mobile terminal 100.

Referring to FIG. 12, the controller 180 can periodically acquires images through the camera 121 and determine that the baby 52 currently holds the mobile terminal 100 if the acquired images do not include the face of the mother 51 who is the user previously registered or if the face of the baby 52 is larger than the face of the mother 51 even though the acquired images include the face of the mother 51.

As described above, the controller 180 can change the idle screen provided to the display unit 151 in consideration of both the obtained current location and the user currently holding the mobile terminal.

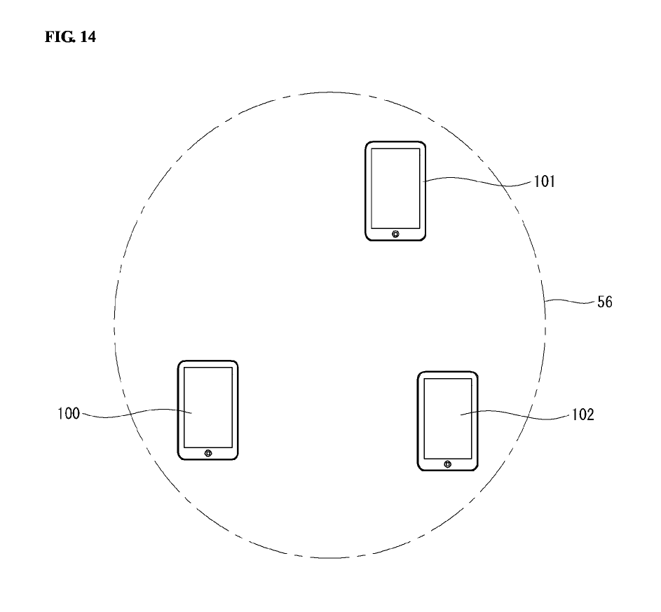

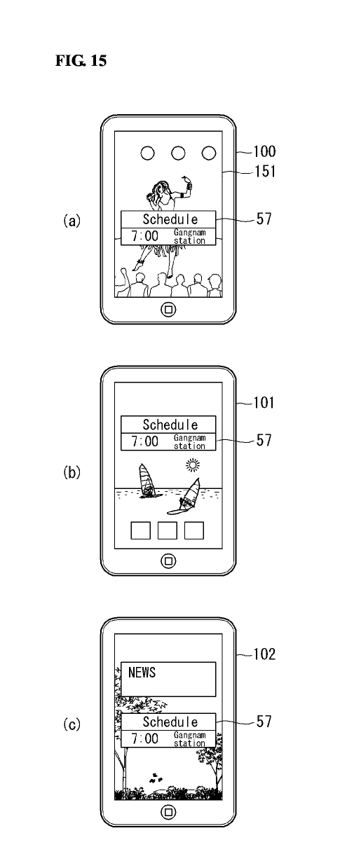

FIG. 14 illustrates an exemplary environment to which a method of controlling a mobile terminal according to a third embodiment of the present invention can be applied and FIG. 15 illustrates an implementation of the method of controlling a mobile terminal according to the third embodiment of the present invention.

A method of managing icons of a mobile terminal according to the third embodiment of the present invention may be implemented in the mobile terminal 100 described with reference to FIG. 1. The method of controlling a mobile terminal according to the third embodiment of the present invention and an operation of the mobile terminal 100 for implementing the controlling method will now be explained with reference to required drawings.

Referring to FIGS. 1 and 14, the mobile terminal 100 may be located in the same place 56 where mobile terminals 101 and 102 of users who belong to the same group in which the user of the mobile terminal 100 is included.

The same group may have various meanings.

For example, users registered as friends according to SNS may be considered to belong to the same group.

In addition, users registered as friends according to an instant messaging (IN) service may be considered to belong to the same group.

Furthermore, friends mutually registered in phone books of mobile terminals may be considered to belong to the same group.

Moreover, people mentioned in a specific file or specific contents and the user of the mobile terminal 100 may be considered to belong to the same group. For example, when the users of the mobile terminals 101 and 102 are included in specific schedule information stored in the memory 160, the user of the mobile terminal 100 and the users of the mobile terminals 101 and 102 can be considered to belong to the same group.

In the environment shown in FIG. 14, the controller 180 may share specific information with the mobile terminals 101 and 102 and provide an idle screen including the specific information to the display unit 151.

Referring to FIG. 15(a), the controller 180 may display schedule information 57 on the display unit 151 and share the schedule information 57 with the mobile terminals 101 and 102. To achieve this, the controller 180 may transmit the schedule information 57 to the mobile terminals 101 and 102 through the wireless communication unit 110. In addition, the controller 180 may transmit a command signal for displaying the schedule information 57 on the idle screen together with the schedule information 57 to the mobile terminals 101 and 102.

Referring to FIGS. 15(b) and 15(c), the mobile terminals 101 and 102 may respectively display the schedule information 57 on their idle screens when receiving the command signal.

The mobile terminals 100, 101 and 102 which belong to the same group and is located in the same place may display the same idle screen including the schedule information 57 or display the schedule information 57 on different idle screens. FIG. 15 illustrates the case that the mobile terminals 100, 101 and 102 display the schedule information 57 on different idle screens.

To display the same idle screen including the schedule information 57 on the mobile terminals 100, 101 and 102, the mobile terminal 100 may transmit the idle screen including the schedule information 57 to the mobile terminals 101 and 102 or transmit configuration information of the idle screen to the mobile terminals 101 and 102.

To implement the third embodiment of the present invention, the mobile terminals belonging to the same group may be constructed such that they share an application providing the function relating to the third embodiment of the present invention or provide at least the function relating to the third embodiment of the present invention.

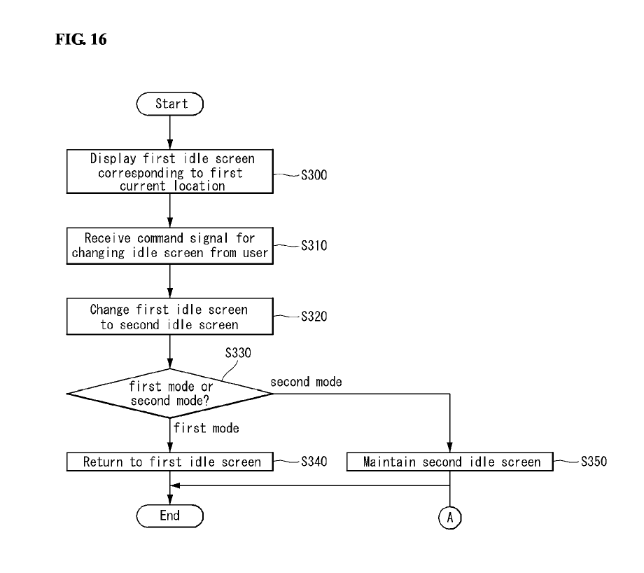

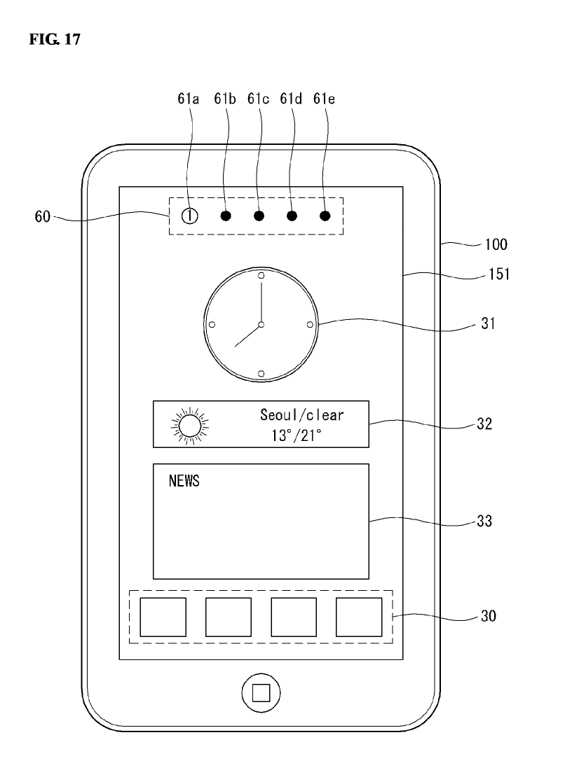

FIG. 16 is a flowchart showing a method of controlling a mobile terminal according to a fourth embodiment of the present invention and FIGS. 17, 18 and 19 are views for explaining the method of controlling a mobile terminal according to the fourth embodiment of the present invention.

A method of managing icons of a mobile terminal according to the fourth embodiment of the present invention may be implemented in the mobile terminal 100 described with reference to FIG. 1. The method of controlling a mobile terminal according to the fourth embodiment of the present invention and an operation of the mobile terminal 100 for implementing the controlling method will now be explained with reference to required drawings.

Referring to FIGS. 1 and 16, the controller 16 may display a first idle screen corresponding to a first current location of the mobile terminal 100 on the display unit 151 according to the aforementioned embodiments of the present invention in operation S300.

FIG. 17 shows an idle screen similar to the idle screen shown in FIG. 4, which is displayed on the display unit 151 according to the operation S300. The idle screen shown in FIG. 17 includes an indicator region 60 for indicating multiple idle screens, distinguished from the idle screen shown in FIG. 4.

The mobile terminal 100 can provide multiple idle screens. The multiple idle screens may be referred to as multiple home screens. The multiple idle screens are switched such that one of the multiple idle screens can be displayed on the display unit 151.

Indicators 61a, 61b, 61c, 61d and 61e included in the indicator region 60 respectively correspond to the multiple idle screens. FIG. 17 illustrates an idle screen corresponding to a first indicator 61a among the indicators 61a, 61b, 61c, 61d and 61e, displayed on the display unit 151. That is, the idle screen currently displayed on the display unit 151 corresponds to the first one of five idle screens.

The second, third, fourth and fifth indicators 61b, 62c, 62d and 62e respectively indicate idle screens which are not currently displayed on the display unit 151. That is, the number of idle screens which are not currently displayed on the display unit 151 is four.

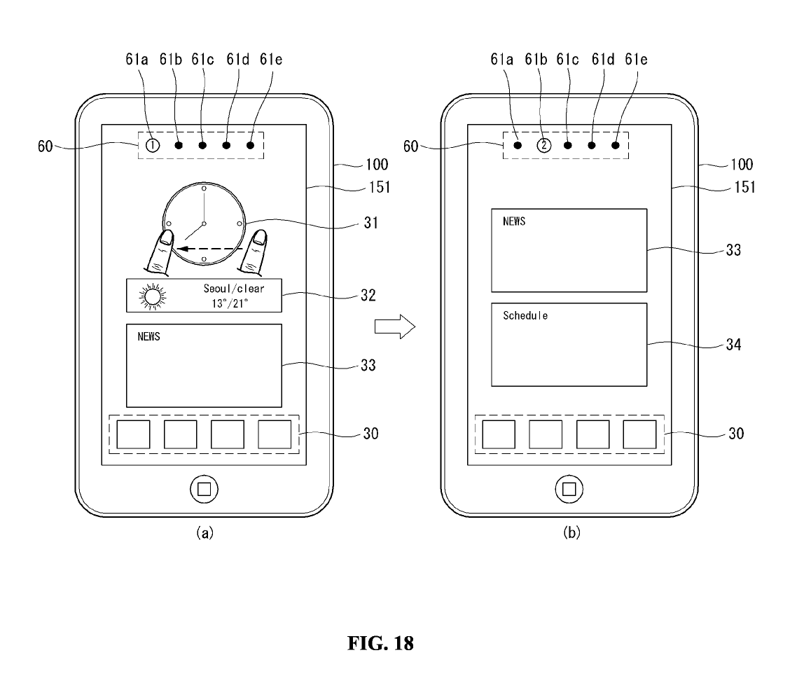

The controller 180 may receive a command signal for changing the idle screen from the user in operation S310. Referring to FIG. 18(a), the user can drag the idle screen shown in FIG. 17 using a finger from the left to the right.

The controller 180 may change the first idle screen to a second idle screen according to the command signal in operation S320. Referring to FIG. 18(b), the second idle screen corresponding to the second indicator 61b among the five idle screens is displayed on the display unit 151 according to the user's drag operation shown in FIG. 18(a).

After the first idle screen is changed to the second idle screen, the controller 180 may perform one of an operation of returning to the first idle screen from the second idle screen and an operation of maintaining the second idle screen after a lapse of predetermined time according to configurations.

Referring to FIG. 16, the controller 180 can determine whether the current mode corresponds to a first mode or a second mode in operation S330. When the current mode is the first mode, the controller 180 can control the display unit 151 to display the first idle screen after a lapse of predetermined time from when the first idle screen is changed to the second idle screen in operation S340.

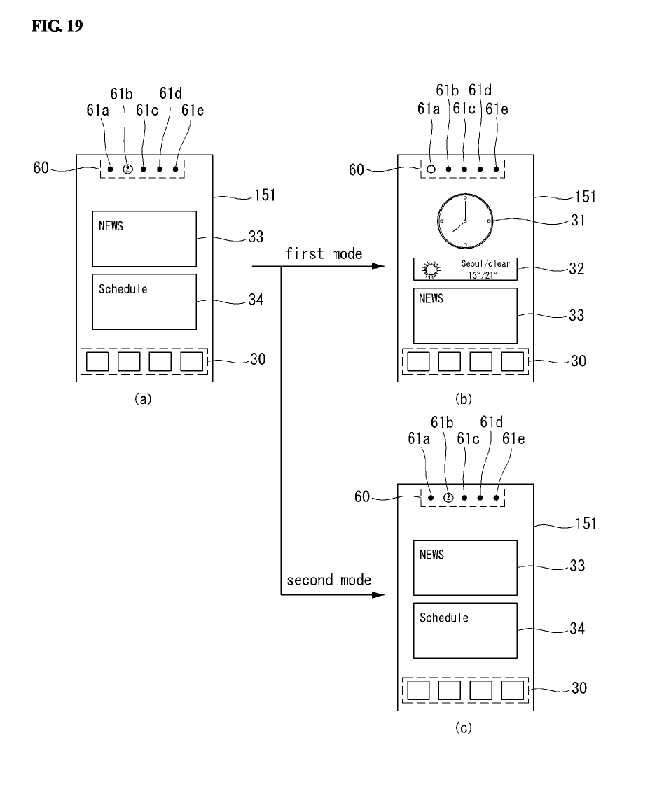

FIG. 19 illustrates implementations of the operations S330, S340 and S350 shown in FIG. 16.

Referring to FIG. 19, when the current mode is set to the first mode, the second idle screen shown in FIG. 19(a) can be changed to the first idle screen, as shown in FIG. 19(b), after the lap of predetermined time while the second idle screen is displayed.

The controller 180 can maintain the second idle screen when the current mode is the second mode in operation S350.

Referring to FIG. 19, when the current mode is set to the second mode, even if the predetermined time passes while the second idle screen is displayed as shown in FIG. 19(a), the second idle screen can be maintained as shown in FIG. 19(c).

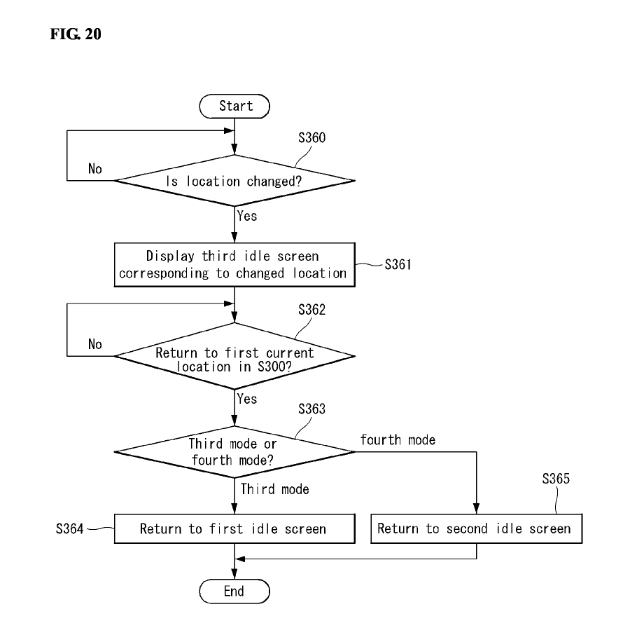

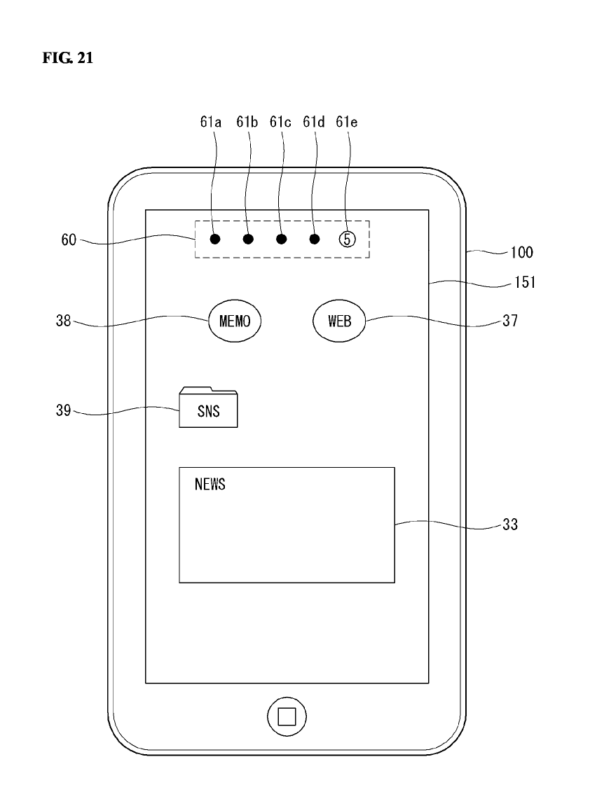

FIG. 20 is a flowchart showing a method of controlling a mobile terminal according to a fifth embodiment of the present invention and FIGS. 21 through 26 are views for explaining the method of controlling a mobile terminal according to the fifth embodiment of the present invention.

A method of managing icons of a mobile terminal according to the fifth embodiment of the present invention may be implemented in the mobile terminal 100 described with reference to FIG. 1. The method of controlling a mobile terminal according to the fifth embodiment of the present invention and an operation of the mobile terminal 100 for implementing the controlling method will now be explained with reference to required drawings.

The method of managing icons of a mobile terminal according to the fifth embodiment of the present invention may be based on the method of managing icons of a mobile terminal according to the fourth embodiment of the present invention. The method of managing icons of a mobile terminal according to the fifth embodiment of the present invention will now be explained based on the method of managing icons of a mobile terminal according to the fourth embodiment of the present invention for convenience of explanation.

Referring to FIGS. 1 and 20, the controller 180 may determine whether the first current location of the mobile terminal 100 in the fourth embodiment of the present invention is changed to a second current location in operation S360.

When the user of the mobile terminal 100 moves to a specific place (corresponding to the second current location) from home (corresponding to the first current location) carrying the mobile terminal 100, for example, the controller 180 can display a third idle screen corresponding to the second current location on the display unit 151 in operation S361.

FIG. 21 illustrates an example of the third idle screen displayed on the display unit 151.

The controller 180 may determine whether the mobile terminal 100 returns to the first current location, described in operation S300, in operation S362 and, when the mobile terminal 100 returns to the first current location, determine whether the current mode is set to a third mode or a fourth mode in operation S363.

When the current mode is set to the third mode, the controller 180 may display the first idle screen corresponding to the first current location on the display unit 151 as the mobile terminal 100 returns to the first current location from the second current location in operation S364.

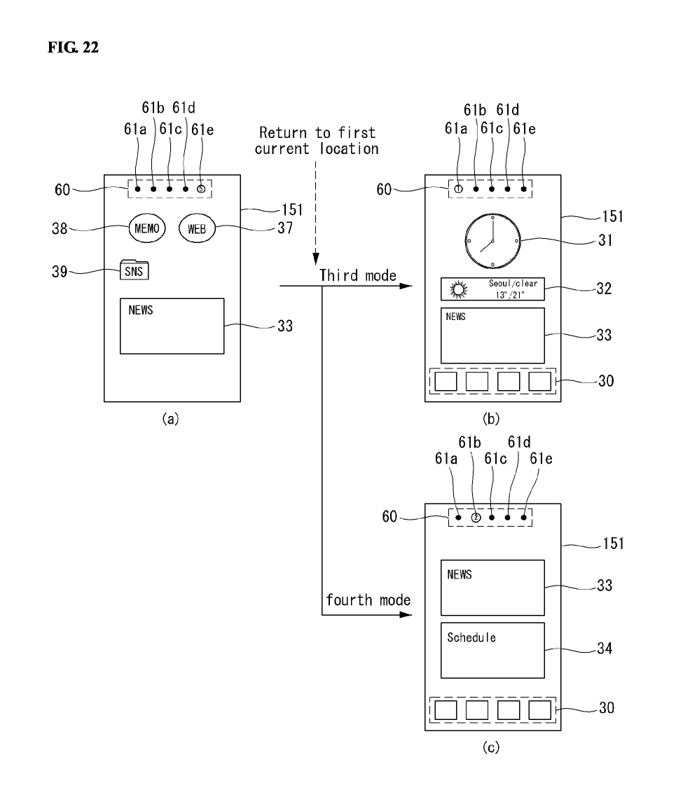

FIG. 22 illustrates implementations of the operations S362 through S365.

Referring to FIG. 22, when the current mode is set to the third mode, if the mobile terminal 100 returns to the first current location while the third idle screen is displayed as shown in FIG. 22(a), the third idle screen can be changed to the first idle screen as shown in FIG. 22(b).

When it is determined that the current mode is set to the fourth mode in operation S363, the controller 280 can display the second idle screen, which was provided right before the current location of the mobile terminal 100 is changed to the second current location, on the display unit 151 in operation S365.

Referring to FIG. 22, when the current mode is set to the fourth mode, if the mobile terminal returns to the first current location while the third idle screen is displayed as shown in FIG. 22(a), the third idle screen can be changed to the second idle screen, as shown in FIG. 22(c).

FIGS. 23, 24, 25 and 26 illustrate other implementations of the fourth and fifth embodiments of the present invention.

Referring to FIG. 23, the controller 180 can display the first idle screen corresponding to the first current location on the display unit 151, as shown in FIG. 23(a), in the operation S300 shown in FIG. 16. When the controller 180 receives the command signal for changing the idle screen from the user in the operation S310 shown in FIG. 16, the controller 180 can change the first idle screen to the second idle screen corresponding to the command signal in operation S320 shown in FIG. 16.

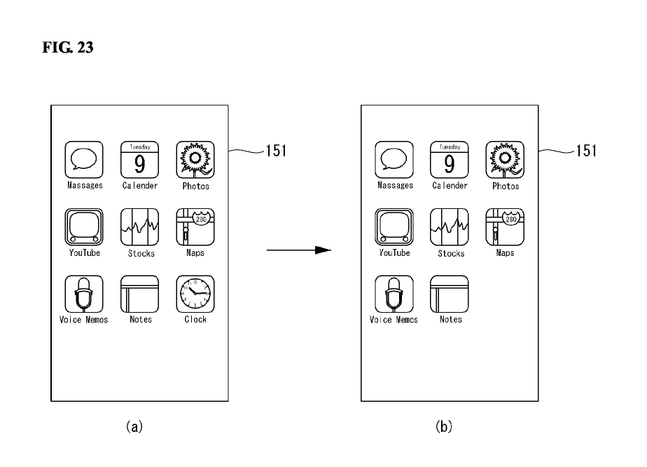

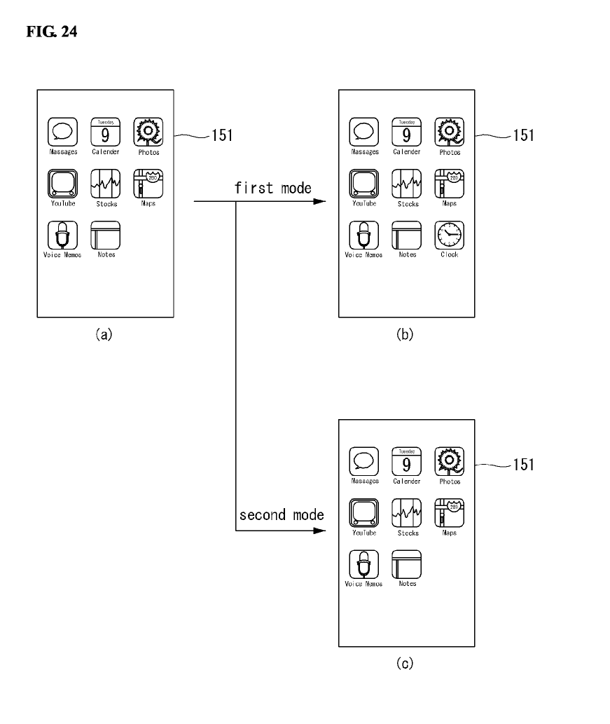

The controller 180 determines whether the current mode corresponds to the first mode or the second mode in the operation S330 shown in FIG. 16 and, when the current mode is the first mode, change the second idle screen to the first idle screen after the lapse of predetermined time in the operation S340 shown in FIG. 16, as shown in FIG. 24.

When the second idle screen is continuously maintained in the operation S350 shown in FIG. 16, the controller 180 can determine whether or not the mobile terminal 100 located in the first current location moves to the second current location corresponding to another place in operation S360 shown in FIG. 20.

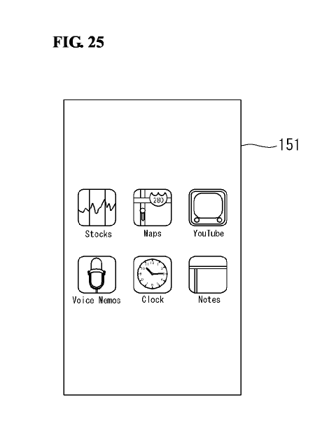

When it is determined that the current location of the mobile terminal 100 is changed from the first current location to the second current location in the operation S360, the controller 180 can display the third idle screen corresponding to the second current location on the display unit 151 in the operation S361 shown in FIG. 20, as shown in FIG. 25.

In addition, the controller 180 can determine whether of not the current location of the mobile terminal 100 returns to the first current location from the second current location in the operation S362 shown in FIG. 20 and, when the current location of the mobile terminal 100 returns to the first current location, determine whether the current mode is set to the third mode or the fourth mode in the operation S363 shown in FIG. 20.

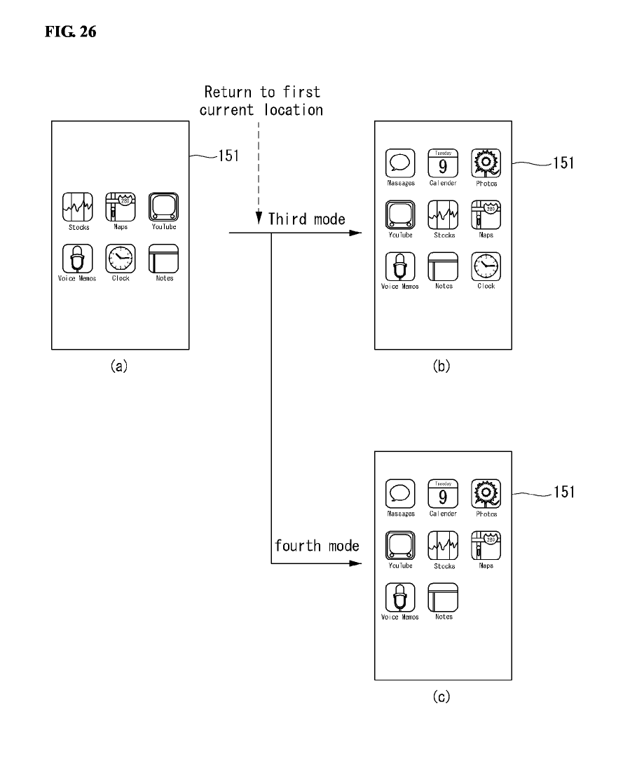

When the current mode is set to the third mode, the controller 180 can control the display unit 151 to display the first idle screen as the mobile terminal 100 returns to the first current location in the operation S364 shown in FIG. 20, as shown in FIG. 26. When the current mode is set to the fourth mode, the controller 180 can control the display unit 151 to display the second idle screen as the mobile terminal 100 returns to the first current location in the operation S365 shown in FIG. 20, as shown in FIG. 26.

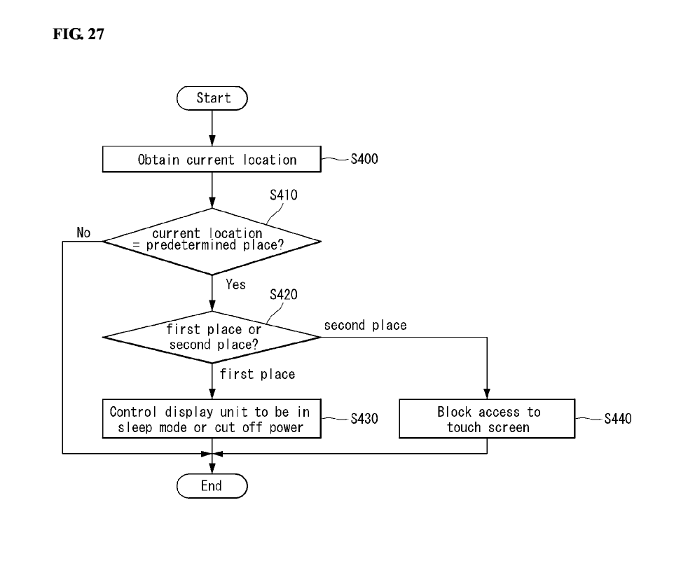

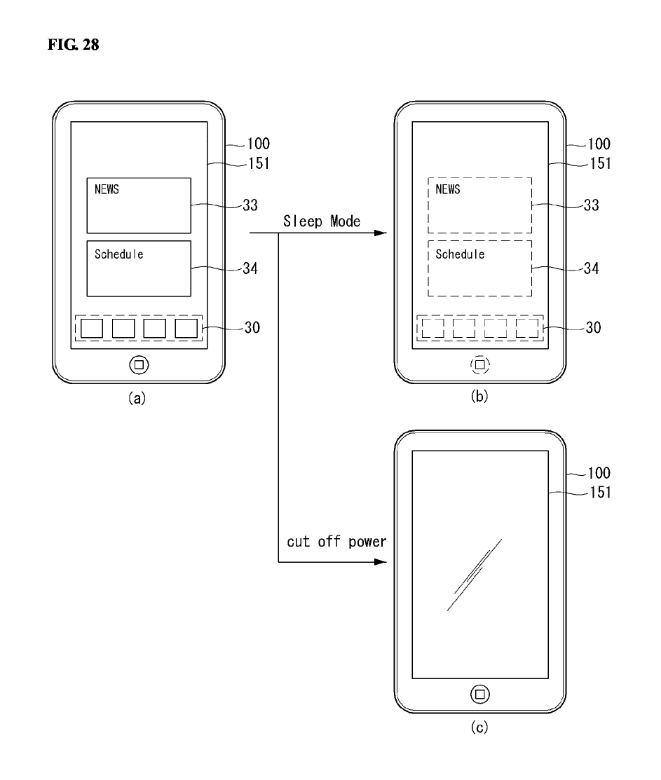

FIG. 27 is a flowchart showing a method of controlling a mobile terminal according to a sixth embodiment of the present invention and FIG. 28 is a view for explaining the method of controlling a mobile terminal according to the sixth embodiment of the present invention.

A method of managing icons of a mobile terminal according to the sixth embodiment of the present invention may be implemented in the mobile terminal 100 described with reference to FIG. 1. The method of controlling a mobile terminal according to the sixth embodiment of the present invention and an operation of the mobile terminal 100 for implementing the controlling method will now be explained with reference to required drawings.

Referring to FIG. 27, the controller 180 may obtain the current location of the mobile terminal 100, as described above, in operation S400. The controller 180 may determine whether the obtained current location corresponds to a predetermined place in operation S410.

When the obtained current location corresponds to the predetermined place, the controller 180 may determine whether the predetermined place corresponds to a first place or a second place in operation S420 and control the display unit 151 to be in a sleep mode or cut off power supplied to the display unit 151 when the predetermined place corresponds to the first place in operation S430.

The sleep mode in which the display unit 151 is seen indistinct weakens the power supplied to the display unit 151 to save power.

When the mobile terminal 100 does not receive any input from the user or does not operate for a predetermined time while the power applied to the display unit 151 corresponds to a peak value (or set value), the mobile terminal 100 can enter the sleep mode, in general. A function of cutting off the power applied to the display unit 151 when the mobile terminal 100 does not receive any input from the user or does not operate for a predetermined time even in the sleep mode is also generally adopted for the mobile terminal 100.

However, the sixth embodiment of the present invention can provide a method of executing the function of changing the mode of the mobile terminal 100 to the sleep mode and the function of cutting off the power applied to the display unit 151 based on the current location of the mobile terminal 100 as well as the method of executing the functions based on the predetermined time.

Referring to FIG. 28, the controller 180 can control the display unit 151 shown in FIG. 28(a) to be in the sleep mode, as shown in FIG. 28(b), or control the display unit 151 shown in FIG. 28(a) to display no information, as shown in FIG. 28(c), by cutting off the power applied to the display unit 151 according to the obtained current location of the mobile terminal 100.

In addition, when the obtained current location corresponds to the second place and the display unit 151 is a touch screen, the controller 180 can block access to the touch screen 151 in operation S440. When the access to the touch screen 151 is blocked, the controller 180 can perform no operation even when the user touches the touch screen 151.

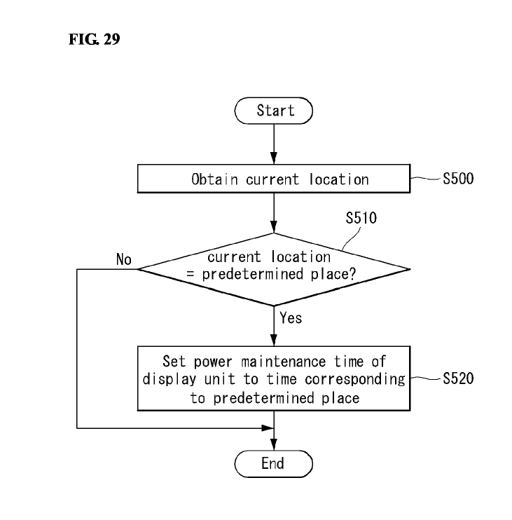

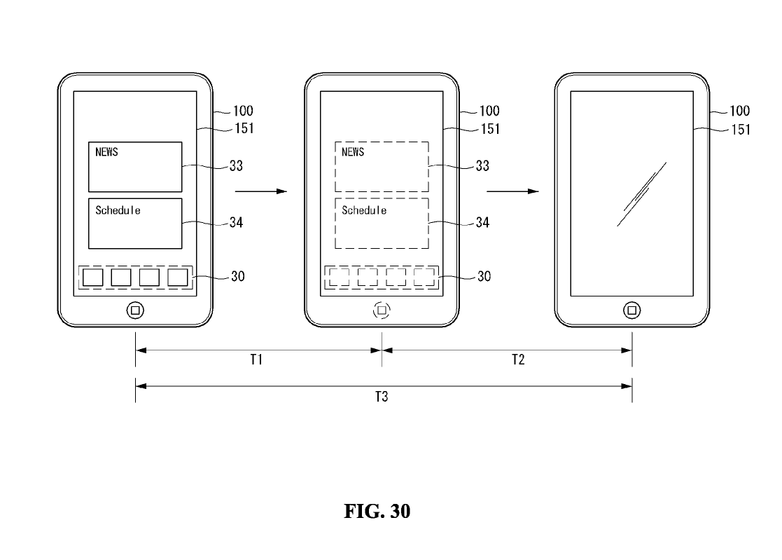

FIG. 29 is a flowchart showing a method of controlling a mobile terminal according to a seventh embodiment of the present invention and FIGS. 30, 31 and 32 are views for explaining the method of controlling a mobile terminal according to the seventh embodiment of the present invention.

A method of managing icons of a mobile terminal according to the seventh embodiment of the present invention may be implemented in the mobile terminal 100 described with reference to FIG. 1. The method of controlling a mobile terminal according to the seventh embodiment of the present invention and an operation of the mobile terminal 100 for implementing the controlling method will now be explained with reference to required drawings.

Referring to FIG. 29, the controller 180 may obtain the current location of the mobile terminal 100, as described above, in operation S500. In addition, the controller 180 may determine whether the current location corresponds to a predetermined place in operation S510.

When the current location corresponds to the predetermined place, the controller 180 may set the power maintenance time of the display unit 151 to a time corresponding to the predetermined place in operation S520.

The power maintenance time of the display unit 151 corresponds to a time period from when the last input of the user or the last operation of the mobile terminal 100 is generated to when the power applied to the display unit 151 is cut off when the mobile terminal 100 does not receive any input from the user or does not operate to save the power applied to the display unit 151.

For example, when the mobile terminal 100 moves to a specific place while the power maintenance time is set to A1, the power maintenance time can be changed from A1 to A2 if the power maintenance time is set to A2 for the specific place.

Referring to FIG. 30, the power maintenance time may be divided into a first power maintenance time T1 required for the mobile terminal 100 to enter the sleep mode and a second power maintenance time T2 required to cut off the power applied to the display unit 151. The controller 180 may store a table in which the first power maintenance time T1 and the second power maintenance time T2 are matched to specific places or a table in which total power maintenance time T3 is matched to specific places.

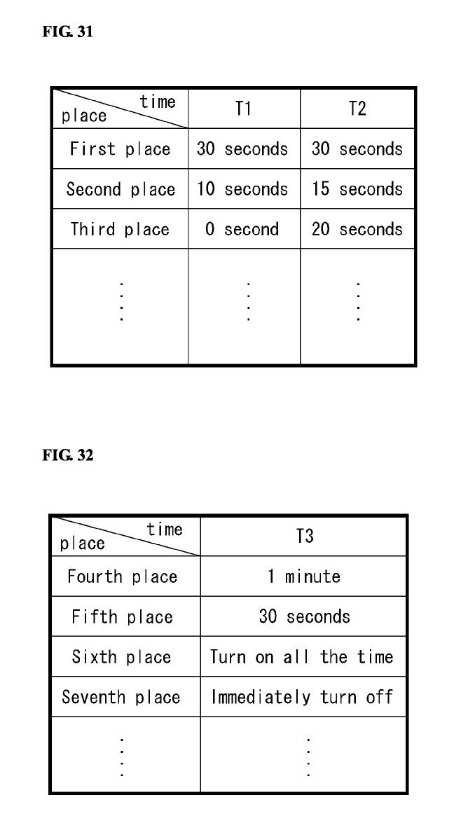

FIG. 31 shows an exemplary table in which the power maintenance time is matched to specific places.

Referring to FIG. 31, the first power maintenance time T1 and the second power maintenance time T2 are respectively set to 30 seconds for a first place. Accordingly, when the mobile terminal 100 moves to the first place, the controller 180 can control the display unit 151 to be in the sleep mode after a lapse of 30 seconds from when the last input of the user is generated, and then cut off the power applied to the display unit 151 after a lapse of 30 seconds from when the display mode 151 enters the sleep mode according to the table shown in FIG. 31 if the mobile terminal 100 does not receive any input from the user even after the display unit 151 enters the sleep mode.

In addition, the first power maintenance time T1 and the second power maintenance time T2 are respectively set to 0 second and 20 seconds for a third place, as shown in FIG. 31. Accordingly, when the mobile terminal 100 is located in the third place, the controller 180 can immediately control the display unit 151 to be in the sleep mode after the last input of the user is generated, and then cut off the power applied to the display unit 151 if the mobile terminal 100 does not receive any input from the user for 20 seconds from when the display unit 151 enters the sleep mode.

The user can personally set the table shown in FIG. 31. For example, the user can set the power maintenance time of the display unit 151 to a minimum value to avoid causing damage to other people in a place like a movie theater.

In addition, the controller 180 may not divide the power maintenance time into the first power maintenance time T1 and the second power maintenance time T2 and may set only the total power maintenance time T3.

Referring to FIG. 32, when the mobile terminal 100 is located in a fifth place, the controller 180 can cut off the power applied to the display unit 151 after a lapse of 30 seconds from when the last input of the user is generated. Here, the controller 180 can arbitrarily set the first power maintenance time T1 and the second power maintenance time T2 within 30 seconds.

In addition, the controller 180 can maintain the display unit 151 in its turn-on state when the mobile terminal 100 is located in a sixth place and the controller 180 can immediately cut off the power applied to the display unit 151 when the mobile terminal 100 is located in a seventh place.

As described above, the position information module 115 can obtain the current location of the mobile terminal 100 through GNSS, cell-ID method and wireless LAN access point detecting method.

A method of obtaining the current location of the mobile terminal 100 using the cell-ID method and the wireless LAN access point detecting method will now be explained in detail with reference to FIGS. 33 and 34.

The position information module 115 can obtain position information using the cell-ID method. The cell-ID method uses a plurality of base stations 200 of a wireless communication system (refer to FIG. 33). A representative of the wireless communication system is CDMA, GSM or WCDMA mobile communication system.

The location of the mobile terminal 100 can be obtained using identification information (for example, base station ID) of at least one base station 200 corresponding to an area in which the mobile terminal 100 is located and information on the intensity of a signal received from the base station. The cell-ID method can obtain a position using one or two base stations or obtain a more accurate position through triangulation using three base stations. That is, different cell-ID methods can be used according to the number of base stations and an error range can be reduced as the number of base stations increases.

In addition, the position information module 115 can obtain position information using the wireless LAN access point detecting method. FIG. 34 illustrates a wireless LAN system communicating with the mobile terminal 100 shown in FIG. 1.

In general, the wireless LAN system can include a plurality of access points (APs) corresponding to end points of a backbone network. The wireless LAN system can recognize information about the locations of the access points. In addition, the information about the locations of the access points can be administrated by specific areas or by the access points.

The mobile terminal 100 can perform wireless communication with the access points according to wireless LAN. Accordingly, the mobile terminal 100 can acquire information about the current location of the mobile terminal 100 through the wireless communication with the access points.

The above described method of controlling a mobile terminal according to the present invention can be written as computer programs and can be implemented in digital computers that execute the programs using a computer readable recording medium. The method of controlling a mobile terminal according to embodiments of the present invention can be executed through software. The software can include code segments that perform required tasks. Programs or code segments can also be stored in a processor readable medium and transmitted.

The computer readable recording medium includes all types of recording devices storing data readable by computer systems. Examples of the computer readable recording medium include ROM, RAM, CD-ROM, DVD±ROM, DVD-RAM, magnetic tapes, floppy disks, hard disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mobile terminal comprising:
a display unit;
a position information unit configured to obtain the current location of the mobile terminal; and
a controller configured to control the position information unit to obtain the current location and controlling an idle screen displayed on the display unit according to the obtained current location.

2. The mobile terminal of claim 1, further comprising a memory configured to store information about multiple idle screens respectively having different configurations,
wherein the controller selects a specific idle screen corresponding to the current location from the multiple idle screens and displays the selected idle screen according to the configuration of the selected idle screen.

3. The mobile terminal of claim 2, wherein the idle screens respectively have different icon configurations according to a variation in the current location.

4. The mobile terminal of claim 3, wherein the controller provides an icon corresponding to an emergency call to the idle screen when the current location is included in a danger zone or deviated from a daily route.

5. The mobile terminal of claim 2, wherein the controller generates the information about the multiple idle screens respectively corresponding to multiple locations based on data about moving routes of the mobile terminal, accumulated for a predetermined time, and stores the information in the memory.

6. The mobile terminal of claim 1, wherein when a user changes a first idle screen corresponding to a first current location as the current location to a second idle screen while the first idle screen is displayed on the display unit, the controller performs one of an operation of maintaining the second idle screen and an operation of returning to the first idle screen after a lapse of predetermined time according to configurations.

7. The mobile terminal of claim 6, wherein the controller displays a third idle screen corresponding to a second current location on the display unit when the operation of maintaining the second idle screen is performed and the first current location is changed to the second current location, and performs one of the operation of returning to the first idle screen and an operation of returning to the second idle screen when the second current location is changed to the first current location.

8. The mobile terminal of claim 1, wherein the controller controls the idle screen in consideration of both the obtained current location and a user who currently holds the mobile terminal.

9. The mobile terminal of claim 8, wherein the controller changes the idle screen provided to the display unit in consideration of both the obtained current location and the user who currently holds the mobile terminal.

10. The mobile terminal of claim 8, wherein when at least one mobile terminal whose user belongs to the same group to which the user of the mobile terminal belongs is located in a place corresponding to the obtained current location, the controller shares specific information with the at least one mobile terminal and displays the shared specific information on the idle screen.

11. A mobile terminal comprising:
a display unit;
a position information unit obtaining the current location of the mobile terminal; and
a controller controlling the position information unit to obtain the current location and variably controlling the state of the display unit according to the obtained current location.

12. The mobile terminal of claim 11, wherein the controller controls the display unit to be in a sleep mode or cuts off power applied to the display unit when the current location corresponds to a predetermined place.

13. The mobile terminal of claim 11, wherein when the display unit is a touch screen and the current location corresponds to a predetermined place, the controller blocks access to the touch screen.

14. A method of controlling a mobile terminal, comprising the steps of:
obtaining the current location of the mobile terminal; and
controlling an idle screen displayed on a display unit included in the mobile terminal according to the obtained current location.

15. The method of claim 14, wherein the step of controlling the idle screen comprises the steps of:
selecting a specific idle screen corresponding to the obtained current location from multiple idle screens respectively having different configurations; and
displaying the selected idle screen on the display unit according to the configuration of the selected idle screen.

16. The method of claim 15, wherein the configurations of the idle screens include icon configurations which vary with a variation in the current location.

17. The method of claim 16, wherein the step of controlling the idle screen comprises the step of providing an icon corresponding to an emergency call to the idle screen when the current location is included in a danger zone or deviated from a daily route.

18. The method of claim 14, wherein the step of controlling the idle screen performs one of an operation of maintaining a second idle screen and an operation of returning to the first idle screen after a lapse of predetermined time according to configurations when a user changes a first idle screen corresponding to a first current location as the current location to the second idle screen while the first idle screen is displayed on the display unit.

19. The method of claim 18, wherein the step of controlling the idle screen comprises the steps of:
displaying a third idle screen corresponding to a second current location on the display unit when the operation of maintaining the second idle screen is performed and the first current location is changed to the second current location; and
performing one of the operation of returning to the first idle screen and an operation of returning to the second idle screen when the second current location is changed to the first current location.

20. The method of claim 14, wherein the step of controlling the idle screen controls the idle screen in consideration of both the obtained current location and a user who currently holds the mobile terminal.

21-23. (canceled)
